(19) United States
(12) Patent Application Publication
(10) Pub. No.: US 2011/0320380 A1
(43) Pub. Date: Dec. 29, 2011

(54) VIDEO CONTENT RECOMMENDATIONS

(75) Inventors: Jessica E. Zahn, Renton, WA (US); Erick L. Fejta, Seattle, WA (US)

(73) Assignee: MICROSOFT CORPORATION, Redmond, WA (US)

(21) Appl. No.: 12/822,068

(22) Filed: Jun. 23, 2010

(51) Int. Cl. G06Q 99/00; G06Q 50/00

(52) U.S. Cl. 705/347

(57) ABSTRACT

Video content recommendations are described. In embodiments, a request for a recommendation of video content is received from a client device, and the recommendation includes identifiers of video assets for an optimal viewing schedule for a user. A utility of each video asset can be determined that indicates a social value of a video asset to the user. A time relevance of each video asset can also be determined that indicates how soon the user may select to watch the video asset, based at least in part on the social value of the video asset. The optimal viewing schedule can then be generated based on the utility of each video asset and the time relevance that is associated with each video asset. The optimal viewing schedule includes recommended video assets that, when watched by the user, provide the most social value in the shortest amount of viewing time.

### BACKGROUND

Media content choices, such as movies, music, television programs, and videos, are ever-increasing. The sheer quantity of choices can often leave a viewer with a feeling of nothing to watch, even though there are now hundreds of television channels and an unlimited number of viral videos that may be selected for viewing, such as when browsing Internet videos. Often, a viewer may only have a limited amount of time to devote to watching television and/or browsing videos, yet is left to determine and prioritize what to select for viewing from the many choices. Viewers would likely prefer not to waste a limited amount of viewing time searching for something to watch, or watching video content that is irrelevant or otherwise not of interest to them.

### SUMMARY

This summary is provided to introduce simplified concepts of video content recommendations that are further described below in the Detailed Description. This summary is not intended to identify essential features of the claimed subject matter, nor is it intended for use in determining the scope of the claimed subject matter.

Video content recommendations are described. In embodiments, a request for a recommendation of video content is received from a client device, and the recommendation includes identifiers of video assets for an optimal viewing schedule for a user. A utility of each video asset can be determined that indicates a social value of a video asset to the user. A time relevance of each video asset can also be determined that is an indication of how soon the user may select to watch the video asset, based at least in part on the social value of the video asset. The optimal viewing schedule can then be generated based on the utility of each video asset and the time relevance that is associated with each video asset. The optimal viewing schedule includes the identifiers of recommended video assets that, when watched by the user, provide the most social value in the shortest amount of viewing time. The recommended video assets can include any one or combination of television programs, movies, viral videos, or music videos.

In other embodiments, the utility of a video asset can be determined, based in part, on a personal value of the video asset to the user, where the personal value is based on a video asset selection history and/or user preferences. Alternatively or in addition, the utility of a video asset can be determined based on predictions of the video assets that social network contacts of the user will likely select for viewing, where the social value to the user is the recommendation to watch one or more of the same video assets that the social network contacts select for viewing. Alternatively or in addition, the utility of a video asset can be determined based on the video assets that the user has previously watched, the video assets that social network contacts of the user have previously watched, and predictions of the video assets that the social network contacts will likely select to watch.

In other embodiments, a diversity of each video asset can be assessed to determine the utility of a video asset, where the social value of a video asset to the user also indicates a uniqueness of the video asset. A discount function can be applied to the social value of one or more of the video assets, or to all but one of the video assets that include similar subject matter. A recommended video asset may include similar subject matter as one or more of the other video assets, and is recommended as a representative video asset to provide the most social value in the shortest amount of viewing time. The optimal viewing schedule can be communicated to the client device for user selection of a recommended video asset. The user selection of the recommended video asset can then be received back from the client device, which then initiates redetermination of the utility of each video asset to update the optimal viewing schedule for the user.

### BRIEF DESCRIPTION OF THE DRAWINGS

Embodiments of video content recommendations are described with reference to the following drawings. The same numbers are used throughout the drawings to reference like features and components:

FIG. 1 illustrates an example system in which embodiments of video content recommendations can be implemented.

FIG. 2 illustrates another example system in which embodiments of video content recommendations can be implemented.

FIG. 3 illustrates an example of determining a value of a video asset at a particular time, as described in accordance with one or more embodiments.

FIG. 4 illustrates an example system with multiple devices that can implement various embodiments of video content recommendations for a seamless user experience in ubiquitous environments.

FIG. 5 illustrates additional example method(s) of video content recommendations in accordance with one or more embodiments.

FIG. 6 illustrates various components of an example device that can implement embodiments of video content recommendations.

### DETAILED DESCRIPTION

Video content recommendations are described. In embodiments, an optimal viewing schedule of recommended video content can be determined for a user of a client device, where the recommended video content includes any combination of video assets, such as television programs, movies, viral videos, or music videos. The optimal viewing schedule includes identifiers of the recommended video assets that, when watched by the user, provide the most social value in the shortest amount of viewing time. In embodiments, various video assets are evaluated based on utility and time relevance. The utility of a video asset indicates a social value of the video asset to the user. Additionally, the utility of the video asset is an indication of how many friends are or will likely watch the video content, and how interesting the video content is to the user given the selection history and preferences of the user.

The time relevance associated with a video asset is an indication of how notable, or “buzz-worthy”, the video content is and/or how new the video content is, particularly to a group of friends of the user. For example, a viewer may want to know what his or her friends and coworkers are going to be talking about around the water cooler the next day at work, and which television programs and/or viral videos to watch so as to be “in the know”. The viewer will also likely want to know which of the television programs and/or viral videos are actually worth the time to watch. Embodiments of video content recommendations provide that a user of a client device (e.g., a video content viewer) can get a recommendation of which video content is pertinent to watch, and in what order, along with an indication of the social value or importance of the recommended video assets to the user.

While features and concepts of the described systems and methods for video content recommendations can be implemented in any number of different environments, systems, and/or various configurations, embodiments of video content recommendations are described in the context of the following example systems and environments.

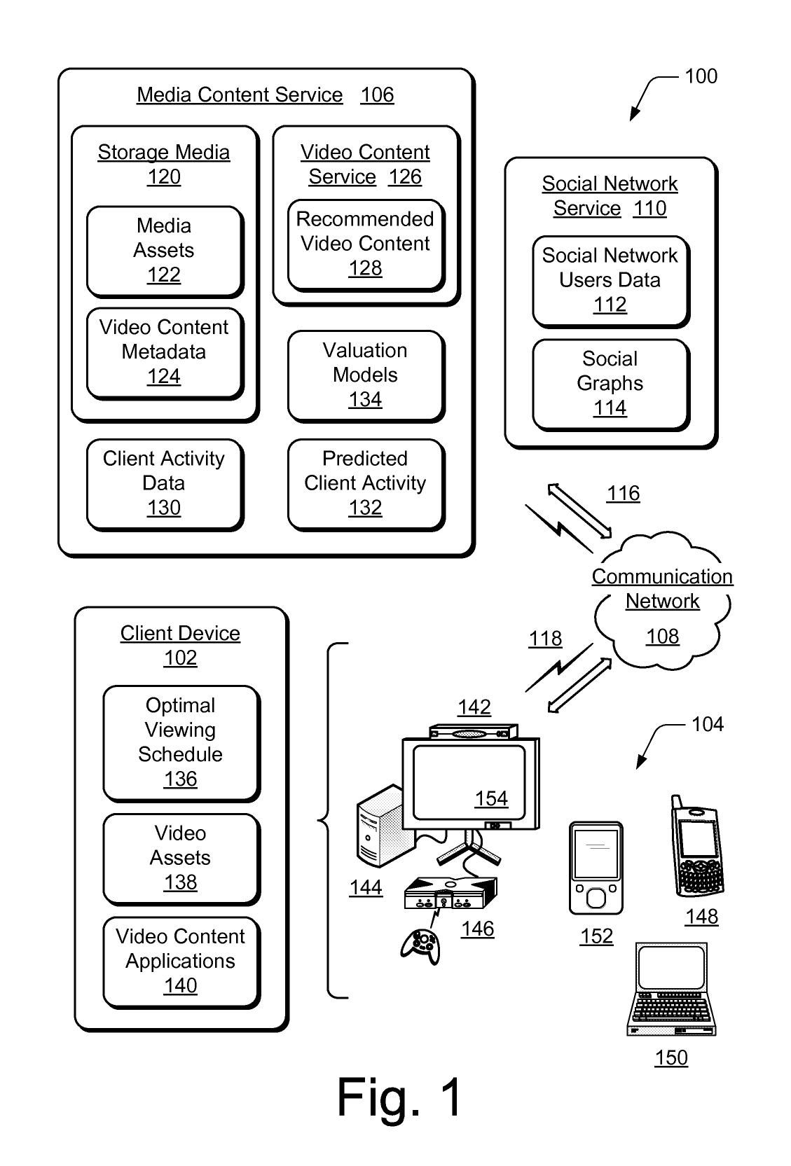

FIG. 1 illustrates an example system 100 in which various embodiments of video content recommendations can be implemented. The example system 100 includes a client device 102, which may be configured as any type of client device 104. Some of the various client devices 104 include wired and/or wireless devices, and may also be referred to as user devices and/or portable devices. The example system 100 also includes a media content service 106 and/or other media content sources that communicate or otherwise provide media content and data to any number of the various client devices 104 via a communication network 108.

The example system 100 also includes a social network service 110 that supports social networking by users of the various client devices. The social network service 110 may be implemented as any type of social network site that provides for social network contacts based on any one or combination of social groups, such as co-workers, friends, family, a group based on common interests, a group of unknown contacts that are linked based on some commonality, and so on. The social network service 110 supports social networking by maintaining social network users data 112 that corresponds to social network users of the various client devices. Any of the various social groups are identified in social graphs 114 maintained by the social network service, and a user of the client device 102 may be included in any of the social graphs with other social network contacts and group members. In embodiments, the social network service 110 may also represent groups of social networks, and/or a social graph 114 may represent an aggregate of multiple social networks of which a particular user is a member.

Social network users can be associated with a user of the client device 102, and can utilize the social network service 110 to share media content, upload photos, share URL links, provide status updates, generate blogs, and any other type of social networking with audio, video, and/or image content. The social network service 110 may use a permissioning technique, such as a selected or allowed relationship, to permit or restrict access to content associated with a user account of the social network service. For example, a user of the client device 102 may have an associated user account with the social network service 110, and via the client device 102, the user can select and allow social network contacts of the user, such as in a social graph 114.

The communication network 108 can be implemented to include a broadcast network, an IP-based network 116, and/or a wireless network 118 that facilitates media asset distribution and data communication between the media content service 106, the social network service 110, and any number of the various client devices. The communication network 108 can also be implemented using any type of network topology and/or communication protocol, and can be represented or otherwise implemented as a combination of two or more networks. The communication network 108 may also include a mobile operator network that is managed by a communication service provider, such as a cell-phone provider and/or Internet service provider, to facilitate mobile data and/or voice communications for any type of a wireless device or mobile phone (e.g., cellular, VoIP, Wi-Fi, etc.).

The media content service 106 can include media content servers to communicate, or otherwise distribute, media content and/or other data to any number of the various client devices. In this example system 100, the media content service 106 includes storage media 120 to store or otherwise maintain various media content and data, such as media assets 122 (e.g., also referred to as video assets and/or video content) and associated video content metadata 124. The storage media 120 can be implemented as any type of memory and/or suitable electronic data storage. Additionally, the media content service 106 may be implemented as a subscription-based service from which any of the various client devices 104 can request media assets 122 (e.g., video assets), or recommendations of media assets, to download and display for viewing, or otherwise render for playback. The media content service 106 manages the media asset distribution to the various client devices 104, such as when a request for a media asset 122 is received from a client device 104, and the media content service 106 communicates or provides data segments of the media asset to the client device.

The media assets 122 can include any type of audio, video, and/or image data received from any type of media content source or data source. As described throughout, media assets are media content, and media assets can include music (e.g., digital music files of songs), television programming, movies, on-demand media assets, interactive games, network-based applications, and any other audio, video, and/or image data (e.g., to include program guide data, user interface data, advertising content, closed captions data, content metadata, search results and/or recommendations, etc.). A media asset 122 may also include various display formats of the media asset, such as a high-definition display format and lower quality display formats.

The video content metadata 124 can include any type of identifying criteria, descriptive information, and/or attributes associated with the media assets 122 that describes and/or categorizes the media assets. For example, metadata can include a media asset identifier, title, subject description, a date of production, artistic information, music compilations, and any other types of descriptive information about a particular media asset. Further, metadata can characterize a genre that describes a media asset, such as video content, as being an advertisement, a movie, a comedy show, a sporting event, a news program, a sitcom, a talk show, an action/adventure program, or as any number of other category descriptions.

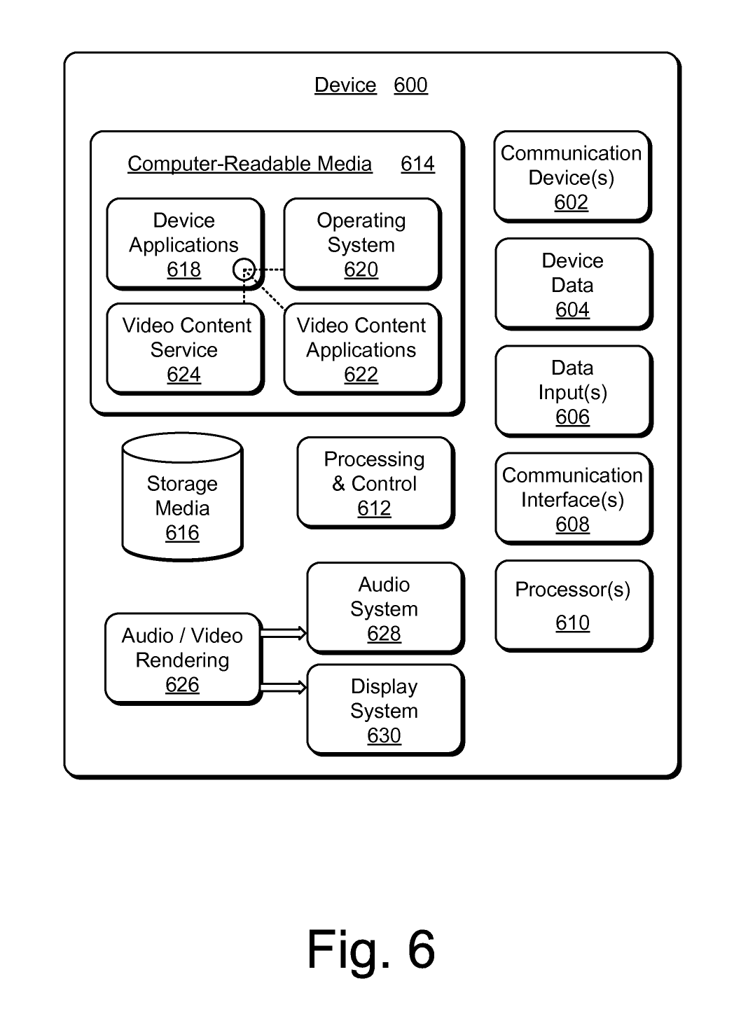

In this example system 100, the media content service 106 includes a video content service 126 that can be implemented as computer-executable instructions and executed by one or more processors to implement the various embodiments described herein for video content recommendations. The media content service 106 can also be implemented with any number and combination of differing components as further described with reference to the example device shown in FIG. 6. Additionally, any of the media content service 106, the social network service 110, and the video content service 126 may be implemented as an independent service (e.g., on a separate server or by a third party service), or as one combined service.

The media content service 106 can receive a request for a recommendation of video content from a client device. For example, a user of the client device 102 can request a recommendation that includes identifiers of video assets for an optimal viewing schedule for the user, and the client device 102 communicates the request to the media content service. In embodiments, the video content service 126 is implemented to then generate recommended video content 128 for the user, where the recommended video content includes video assets, such as any one or combination of television programs, movies, viral videos, or music videos.

The video content service 126 is implemented to determine a utility of the various video assets, where the utility indicates a social value of a video asset to the user. The video content service 126 is also implemented to determine a time relevance of each video asset, where the time relevance is an indication of how soon the user may select to watch the video asset (e.g., or how soon a user may need, in a social sense, to watch the video asset based on relevance, timeliness, etc.). The video content service 126 can then generate an optimal viewing schedule (e.g., the recommended video content 128) based on the utility of each video asset and the time relevance that is associated with each video asset. The optimal viewing schedule can include the identifiers of one or more recommended video assets that, when watched by the user, provide the most social value in the shortest amount of viewing time.

In embodiments, the various video assets are evaluated based on utility and time relevance. The utility of a video asset can be an indication of how many friends are or will likely watch the video content, and how interesting the content is to the user given the selection history and preferences of the user. The time relevance associated with a video asset can be an indication of how notable the video content is and/or how new the video content is, particularly to a group of friends of the user (e.g., as included in a social graph 114). In examples, the finale of a popular talent competition, such as a singing or dancing program, will likely have more time relevance to a user than a new episode of a popular sit-com, or other television series. A social value of the video content may also be considered, such as when the video content is likely to be the topic of news stories, and of some interest to a user. Similarly, new video content will likely have more time relevance and/or social value than a recorded program. The video content service 126 can determine which video assets have the most time relevance and/or social value, are pertinent for the user to watch, and in what order, so that the user does not miss out on the topics of conversation about the video content, such as the next day at work when friends and coworkers are discussing the television programs.

The utility of a video asset can be determined by the video content service 126, based in part, on predictions of the video assets that social network contacts of the user will likely select for viewing. An aspect of the social value to the user is the recommendation to watch one or more of the same video assets that the social network contacts will likely be watching. Alternatively or in addition, the utility of a video asset can be determined, based in part, on a personal value of the video asset to the user, where the personal value is based on a video asset selection history and/or on user preferences. In this example, the media content service 106 includes client activity data 130 that corresponds to any number of users of the various client devices 104. The client activity data 130 can include current user selections of video content at the client device 102 as well as user history and preferences data, such as when a user interacts with the client device 102 to select video content for viewing, initiates recordings of video assets, and/or shares, bookmarks, rates, or comments on various video assets.

In embodiments, the video content service 126 can determine the utility of a video asset based on the video assets that a user has previously watched, the video assets that social network contacts of the user have previously watched, and predictions of the video assets that the social network contacts will likely select to watch. In this example, the media content service 106 also includes predicted client activity 132 that the video content service 126 utilizes to generate valuation models 134. The predicted client activity 132 can include predicted video assets that the user at the client device 102 may select to watch, as well as the video assets that the social network contacts of the user will likely select to watch. A valuation model 134 can be generated as a user profile for any of the users of the various client devices 104, and includes a set of characteristics associated with each user that can be used to predict the utility, social value, and/or time relevance of a video asset to a user. A valuation model 134 can be generated based on a combination of the client activity data 130 and the predicted client activity 132.

In other embodiments, the video content service 126 can assess a diversity of the various video assets to determine the utility of a video asset, where the social value of a video asset to the user also indicates a uniqueness of the video asset. For example, if a popular celebrity is often the topic of discussion among a group of friends, then several videos and uploaded video content that includes the celebrity as subject matter may be evaluated by the video content service 126 for recommendation. For diversity of the recommended video content 128, the video content service 126 can apply a discount function to the social value of one or more of the video assets, or to all but one of the video assets, that include similar subject matter.

For example, if there are several hours worth of video content that pertains to the popular celebrity, but the user only has a limited amount of time to watch some of the video content, then when some of the video content has been selected for viewing by the user, the importance or social value of the remaining un-viewed video content decreases. The discount in social value of subsequent video assets provides that a diversity of video content can be recommended for watching by the user, and the user does not spend all of his or her viewing time on one subject. Accordingly, a recommended video asset may include similar subject matter as one or more other video assets, and is recommended as a representative video asset to provide the most social value in the shortest amount of viewing time for the user.

When an optimal viewing schedule (e.g., the recommended video content 128) is generated for a user by the video content service 126, the media content service 106 can communicate or otherwise deliver the optimal viewing schedule 136 to the client device 102 for user selection of a recommended video asset. For example, the client device 102 receives the optimal viewing schedule 136 from the media content service 106 via the communication network. A user at the client device 102 can select a video asset to watch, and the media content service delivers the video asset 138 for viewing via a video content application 140 that renders the video content for display. The media content service 106 can then receive back the user selection of the recommended video asset from the client device 102, which may then initiate the video content service 126 to re-determine the utility of each video asset to update the optimal viewing schedule for the user.

When a recommended video asset is selected for viewing by the user, the video content service 126 can update the optimal viewing schedule because the utility, social value, and/or time relevance of one or more recommended video assets is a function of previously viewed content. Other factors that may alter the utility, social value, and/or time relevance of video assets in an optimal viewing schedule include: the user may not select the top recommended video asset; the uniqueness of different video content may increase the ranking of a video asset; similar video content may decrease the ranking of a video asset; some video assets may have a higher replay value than other video assets and may be ranked higher in the optimal viewing schedule; and/or some video content, such as music videos, tend to be selected for viewing more often and, although recently viewed, may be included in the optimal viewing schedule.

In the example system 100, a client device 104 can be implemented as any one or combination of a television client device 142 (e.g., a television set-top box, a digital video recorder (DVR), etc.), a computer device 144, a gaming system 146, an appliance device, an electronic device, and/or as any other type of client device or user device that may be implemented to receive media content in any form of audio, video, and/or image data. The various client devices 104 can also include wireless devices implemented to receive and/or communicate wireless data, such as any one or combination of a mobile phone 148 (e.g., cellular, VoIP, WiFi, etc.), a portable computer device 150, a media device 152 (e.g., a personal media player, portable media player, etc.), and/or any other wireless device that can receive media content in any form of audio, video, and/or image data. A client system can include a respective client device and display device 154 that together render or playback any form of audio, video, and/or image media content and media assets. The display device 154 can be implemented as any type of a television, high definition television (HDTV), LCD, or similar display system.

Any of the various client devices 104 can be configured as the client device 102 and implemented with one or more processors, communication components, memory components, signal processing and control circuits, and a media content rendering system. Further, any of the client devices 104 can be implemented with any number and combination of differing components as further described with reference to the example device shown in FIG. 6.

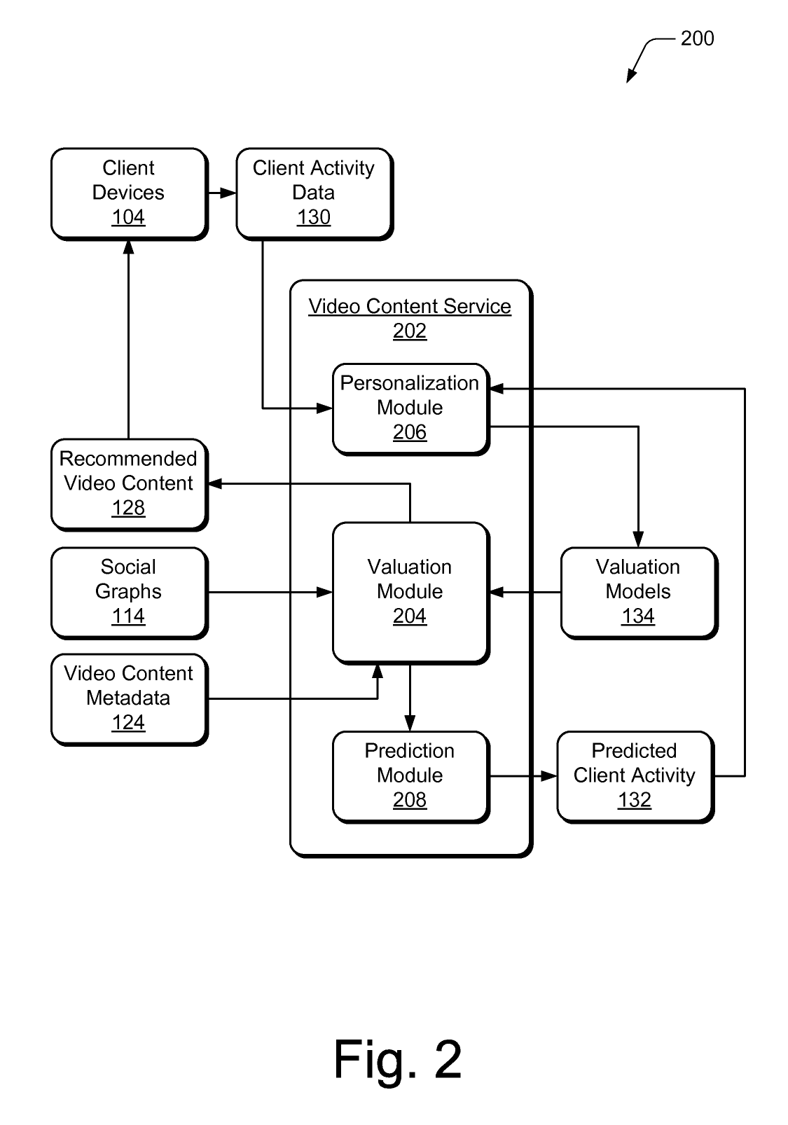

FIG. 2 illustrates an example system 200 that includes various components and data as described above with reference to FIG. 1, and in which various embodiments of video content recommendations can be implemented. In the example system 200, a video content service 202 includes a valuation module 204, a personalization module 206, and a prediction module 208. Any of the valuation module 204, personalization module 206, and prediction module 208 can be implemented as computer-executable instructions and executed by one or more processors to implement the various embodiments described herein for video content recommendations. In embodiments, the video content service 202 is an example of the video content service 126 as described with reference to FIG. 1.

The client activity data 130 includes the current user selections of video content at the client devices 104 as well as user history and preferences data. The client activity data 130 is input to the personalization module 206. The prediction module 208 generates the predicted client activity 132, which includes the predicted video assets that users, and the social network contacts of the users at the client devices 104 may likely select to watch. In embodiments, the prediction module is implemented to predict, based on preferences and previous selections of friends of a user, the video content that the friends of the user may be inclined to watch. For example, if the friends of a user typically watch a popular singing talent competition, then the friends of the user are also likely to be inclined to watch similar video content, such as a dancing talent competition. The prediction module 208 is also implemented to determine how likely a given user is to select the recommended video assets.

The predicted client activity 132 is also input to the personalization module 206 along with the client activity data 130, and the personalization module 206 utilizes both the user history and preferences along with what the prediction module predicts the user will likely want to watch to generate the valuation models 134 as user profiles of each user (e.g., the users of the various client devices 104). The valuation models 134 for each of the users, along with the social graphs 114 for the various social network groups and friends of the users, and the video content metadata 124 are all inputs to the valuation module 204 that generates the recommended video content 128 for the various users at the client devices 104. The valuation module 204 is implemented to determine which video content would likely be of interest to a given user. The prediction module 208 also receives the recommended video content as a feedback input from the valuation module.

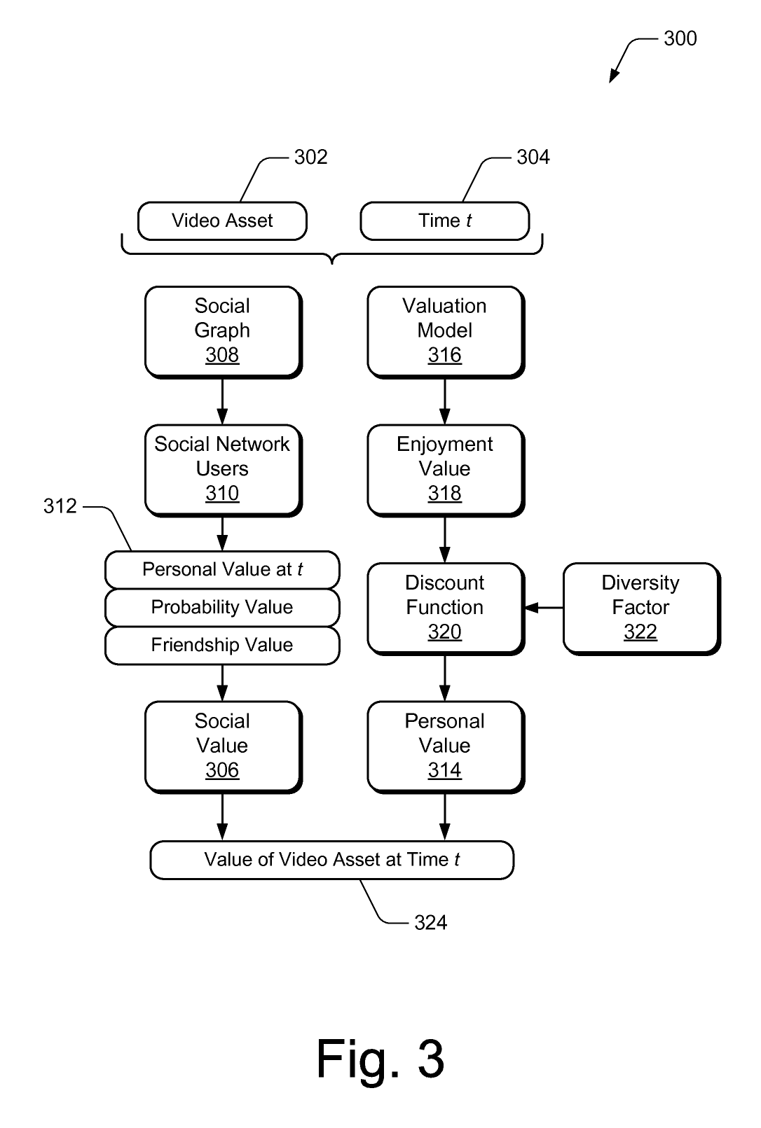

FIG. 3 illustrates an example 300 of determining a value of a video asset at a particular time, as described herein with reference to the various embodiments of video content recommendations. A video asset 302 at a particular time 304 is evaluated by a video content service, such as by one of the video content services described with reference to FIGS. 1 and 2, to determine a social value 306 of the video asset to a user. The video asset 302 at the time 304 is evaluated with reference to a social graph 308 that includes various social network users 310. The value of the video asset 302, with reference to the social network users 310, is then evaluated at 312 taking into account a personal value of the video asset to a user at the time 304, a probability value of the user selecting to watch the video asset 302, and a friendship value that relates the user to one or more of the social network users.

Additionally, the video asset 302 at the particular time 304 is evaluated by the video content service to determine a personal value 314 of the video asset to the user. The video asset 302 at the time 304 is evaluated with reference to a valuation model 316 that corresponds to the user, and determination of an enjoyment value to the user if the user selects to watch the video asset. A discount function 320 may be applied to the video asset 302 based on a diversity factor 322 that is attributable to the video asset due to similar video content subject matter. A value of the video asset 302 to the user at the particular time 304 is then derived at 324 from the social value 306 and the personal value 314 of the video asset to the user.

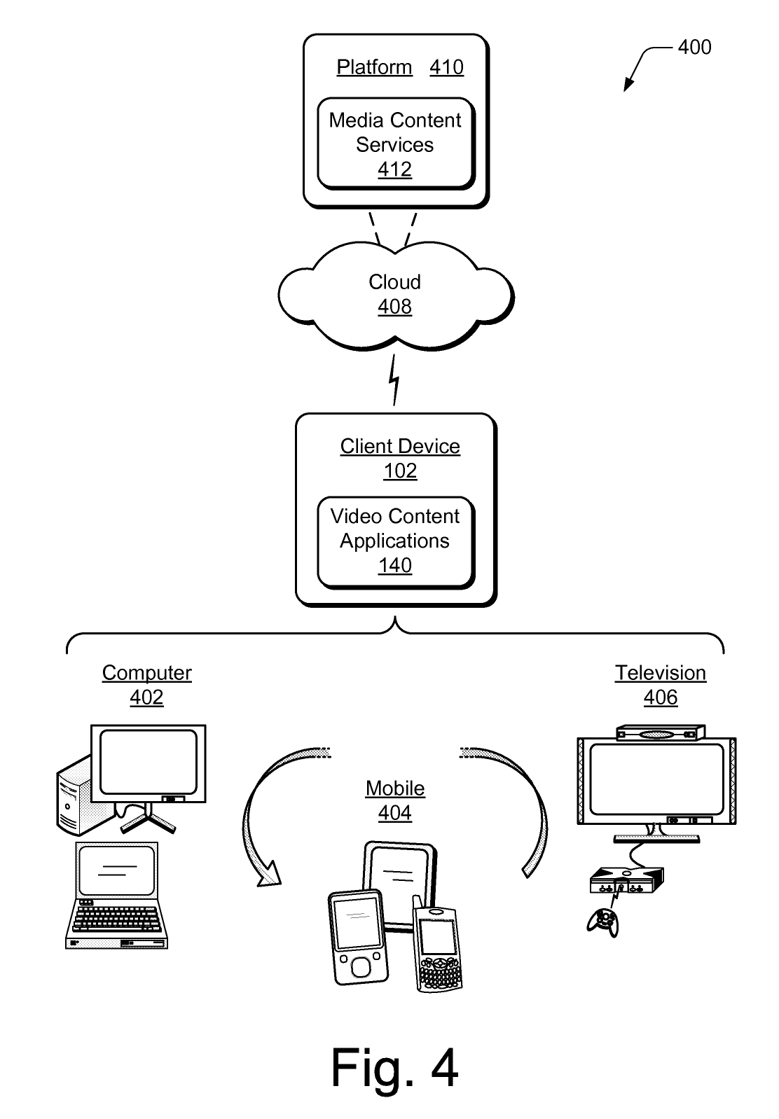

FIG. 4 illustrates an example system 400 that includes the client device 102 as described with reference to FIG. 1. The example system 400 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 400, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link. In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the client device 102 may assume a variety of different configurations, such as for computer 402, mobile 404, and television 406 uses. Each of these configurations includes devices that may have generally different constructs and capabilities, and thus the client device 102 may be configured according to one or more of the different device classes. For instance, the client device 102 may be implemented as the computer 402 class of device that includes a personal computer, desktop computer, a multi-screen computer, laptop computer, netbook, and so on.

The client device 102 may also be implemented as the mobile 404 class of device that includes mobile devices, such as a mobile phone, portable music player, portable gaming device, a tablet computer, a multi-screen computer, and so on. The client device 102 may also be implemented as the television 406 class of device that includes devices having or connected to generally larger screens in casual viewing environments. These devices include televisions, set-top boxes, gaming consoles, and so on. The techniques described herein may be supported by these various configurations of the client device 102 and are not limited to the specific examples of video content recommendations described herein.

The cloud 408 includes and/or is representative of a platform 410 for media content services 412. The platform 410 abstracts underlying functionality of hardware (e.g., servers) and software resources of the cloud 408. The media content services 412 may include applications and/or data that can be utilized while computer processing is executed on servers that are remote from the client device 102. For example, the media content services 412 may include the media content service 106, the social network service 110, and/or the video content service 126 as described with reference to FIG. 1. Media content services 412 can be provided as a service over the Internet and/or through a subscriber network, such as a cellular or WiFi network.

The platform 410 may abstract resources and functions to connect the client device 102 with other computing devices. The platform 410 may also serve to abstract scaling of resources to provide a corresponding level of scale to encountered demand for the media content services 412 that are implemented via the platform 410. Accordingly, in an interconnected device embodiment, implementation of functionality of the video content applications 140 may be distributed throughout the system 400. For example, the video content applications 140 may be implemented in part on the client device 102 as well as via the platform 410 that abstracts the functionality of the cloud 408.

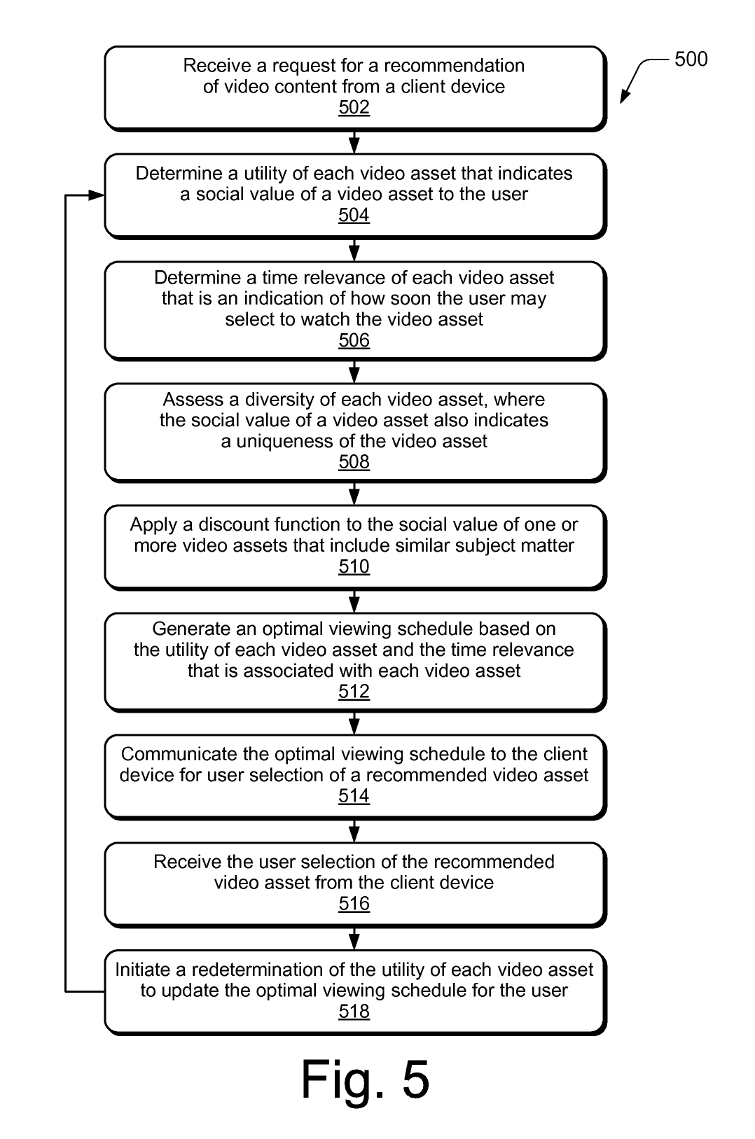

Example method 500 is described with reference to FIG. 5 in accordance with one or more embodiments of video content recommendations. Generally, any of the functions, methods, procedures, components, and modules described herein can be implemented using software, firmware, hardware (e.g., fixed logic circuitry), manual processing, or any combination thereof. A software implementation represents program code that performs specified tasks when executed by a computer processor. The example methods may be described in the general context of computer-executable instructions, which can include software, applications, routines, programs, objects, components, data structures, procedures, modules, functions, and the like. The program code can be stored in one or more computer-readable memory devices, both local and/or remote to a computer processor. The methods may also be practiced in a distributed computing environment by multiple computer devices. Further, the features described herein are platform-independent and can be implemented on a variety of computing platforms having a variety of processors.

FIG. 5 illustrates example method(s) 500 of video content recommendations. The order in which the method blocks are described are not intended to be construed as a limitation, and any number of the described method blocks can be combined in any order to implement a method, or an alternate method.

At block 502, a request is received for a recommendation of video content from a client device. For example, the media content service 106 (FIG. 1) receives a request for a recommendation of video content from the client device 102 when initiated by a user. The recommendation can include identifiers of video assets for an optimal viewing schedule for the user, and in embodiments, the video content service 126 generates recommended video content 128 that includes any one or combination of television programs, movies, viral videos, or music videos.

At block 504, a utility of each video asset is determined that indicates a social value of a video asset to the user. For example, the video content service 126 determines a utility of various video assets, where the utility indicates a social value of a video asset to the user. The utility of a video asset can be determined, based in part, on a personal value of the video asset to the user, where the personal value is based on a video asset selection history and/or user preferences. Alternatively or in addition, the utility of a video asset can be determined based on predictions of the video assets that social network contacts of the user will likely select for viewing, where the social value to the user is the recommendation to watch one or more of the same video assets that the social network contacts are watching. Alternatively or in addition, the utility of a video asset can be determined based on the video assets that the user has previously watched, the video assets that social network contacts of the user have previously watched, and predictions of the video assets that the social network contacts will likely select to watch.

At block 506, a time relevance of each video asset is determined that is an indication of how soon the user may select to watch the video asset, based at least in part on the social value of the video asset. For example, the video content service 126 determines the time relevance of each video asset. At block 508, a diversity of each video asset is assessed, where the social value of a video asset also indicates a uniqueness of the video asset. For example, the video content service 126 assess a diversity of the various video assets to determine the utility of a video asset, where the social value of a video asset to the user also indicates a uniqueness of the video asset.

At block 510, a discount function is applied to the social value of one or more video assets that include similar subject matter. For example, the video content service 126 applies a discount function to the social value of one or more of the video assets, or to all but one of the video assets, that include similar subject matter for diversity of the recommended video content 128. A recommended video asset may include similar subject matter as one or more of the other video assets, and is recommended as a representative video asset to provide the most social value in the shortest amount of viewing time.

At block 512, an optimal viewing schedule is generated based on the utility of each video asset and the time relevance that is associated with each video asset. For example, The video content service 126 generates an optimal viewing schedule (e.g., the recommended video content 128) based on the utility of each video asset and the time relevance that is associated with each video asset. The optimal viewing schedule can include the identifiers of one or more recommended video assets that, when watched by the user, provide the most social value in the shortest amount of viewing time.

At block 514, the optimal viewing schedule is communicated to the client device for user selection of a recommended video asset. For example, the media content service 106 communicates or otherwise delivers the optimal viewing schedule to the client device 102 for user selection of a recommended video asset. At block 516, the user selection of the recommended video asset is received from the client device. For example, the media content service 106 receives back a user selection of a recommended video asset from the client device 102 when a user at the client device 102 selects a video asset to watch.

At block 518, a redetermination of the utility of each video asset is initiated to update the optimal viewing schedule for the user. For example, the video content service 126 re-determines the utility of each video asset to update the optimal viewing schedule for the user when the method continues at block 504. The optimal viewing schedule can be updated when a user selects a recommended video asset to watch because the utility, social value, and/or time relevance of one or more recommended video assets is a function of previously viewed content.

FIG. 6 illustrates various components of an example device 600 that can be implemented as any type of client, server, and/or computing device as described with reference to the previous FIGS. 1-5 to implement embodiments of video content recommendations. In embodiments, device 600 can be implemented as any one or combination of a wired and/or wireless device, as any form of television client device (e.g., television set-top box, digital video recorder (DVR), etc.), consumer device, computer device, server device, portable computer device, user device, communication device, video processing and/or rendering device, appliance device, gaming device, electronic device, and/or as any other type of device. Device 600 may also be associated with a user (i.e., a person) and/or an entity that operates the device such that a device describes logical devices that include users, software, firmware, and/or a combination of devices.

Device 600 includes communication devices 602 that enable wired and/or wireless communication of device data 604 (e.g., received data, data that is being received, data scheduled for broadcast, data packets of the data, etc.). The device data 604 or other device content can include configuration settings of the device, media content stored on the device, and/or information associated with a user of the device. Media content stored on device 600 can include any type of audio, video, and/or image data. Device 600 includes one or more data inputs 606 via which any type of data, media content, and/or inputs can be received, such as user-selectable inputs, messages, music, television media content, recorded video content, and any other type of audio, video, and/or image data received from any content and/or data source.

Device 600 also includes communication interfaces 608 that can be implemented as any one or more of a serial and/or parallel interface, a wireless interface, any type of network interface, a modem, and as any other type of communication interface. The communication interfaces 608 provide a connection and/or communication links between device 600 and a communication network by which other electronic, computing, and communication devices communicate data with device 600.

Device 600 includes one or more processors 610 (e.g., any of microprocessors, controllers, and the like) which process various computer-executable instructions to control the operation of device 600 and to implement embodiments of video content recommendations. Alternatively or in addition, device 600 can be implemented with any one or combination of hardware, firmware, or fixed logic circuitry that is implemented in connection with processing and control circuits which are generally identified at 612. Although not shown, device 600 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 600 also includes computer-readable storage media 614, such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 600 can also include a mass storage media device 616.

Computer-readable storage media 614 provides data storage mechanisms to store the device data 604, as well as various device applications 618 and any other types of information and/or data related to operational aspects of device 600. For example, an operating system 620 can be maintained as a computer application with the computer-readable storage media 614 and executed on processors 610. The device applications 618 may include a device manager, such as any form of a control application, software application, signal processing and control module, code that is native to a particular device, a hardware abstraction layer for a particular device, and so on.

The device applications 618 also include any system components or modules to implement embodiments of video content recommendations. In this example, the device applications 618 can include video content applications 622, such as when device 600 is implemented as a client device. Alternatively or in addition, the device applications 618 can include a video content service 624, such as when device 600 is implemented as a media content service. The video content applications 622 and the video content service 624 are shown as software modules and/or computer applications. Alternatively or in addition, the video content applications 622 and/or the video content service 624 can be implemented as hardware, software, firmware, or any combination thereof.

Device 600 also includes an audio and/or video rendering system 626 that generates and provides audio data to an audio system 628 and/or generates and provides display data to a display system 630. The audio system 628 and/or the display system 630 can include any devices that process, display, and/or otherwise render audio, display, and image data. Display data and audio signals can be communicated from device 600 to an audio device and/or to a display device via an RF (radio frequency) link, S-video link, composite video link, component video link, DVI (digital video interface), analog audio connection, or other similar communication link. In an embodiment, the audio system 628 and/or the display system 630 are implemented as external components to device 600. Alternatively, the audio system 628 and/or the display system 630 are implemented as integrated components of example device 600.

Although embodiments of video content recommendations have been described in language specific to features and/or methods, it is to be understood that the subject of the appended claims is not necessarily limited to the specific features or methods described. Rather, the specific features and methods are disclosed as example implementations of video content recommendations.

1. A computer-implemented method, comprising:
receiving a request for a recommendation of video content from a client device, the recommendation including identifiers of video assets for an optimal viewing schedule for a user;
determining a utility of each video asset that indicates, at least in part, a social value of a video asset to the user;
determining a time relevance of each video asset that is an indication of how soon the user may select to watch the video asset, based at least in part on the social value of the video asset; and
generating the optimal viewing schedule based on the utility of each video asset and the time relevance that is associated with each video asset, the optimal viewing schedule including the identifiers of one or more recommended video assets that, when watched by the user, provide the most social value in the shortest amount of viewing time.

2. A computer-implemented method as recited in claim 1, further comprising assessing a diversity of each video asset to determine the utility of the video asset, wherein the social value of the video asset to the user also indicates a uniqueness of the video asset.

3. A computer-implemented method as recited in claim 1, further comprising applying a discount function to the social value of an additional video asset that includes similar subject matter of the video asset.

4. A computer-implemented method as recited in claim 1, wherein a recommended video asset includes similar subject matter as one or more other video assets, and is recommended as a representative video asset to provide the most social value in the shortest amount of viewing time.

5. A computer-implemented method as recited in claim 1, wherein said determining the utility of the video asset is based, at least in part, on a personal value of the video asset to the user, the personal value based on at least one of a video asset selection history, or user preferences.

6. A computer-implemented method as recited in claim 1, wherein said determining the utility of the video asset is based, at least in part, on predictions of the video assets that social network contacts of the user will select for viewing, and wherein the social value to the user is the recommendation to watch one or more of the same video assets that the social network contacts select for viewing.

7. A computer-implemented method as recited in claim 1, wherein said determining the utility of the video asset is based on the video assets that the user has previously watched, the video assets that social network contacts of the user have previously watched, and predictions of the video assets that the social network contacts of the user will likely select to watch.

8. A computer-implemented method as recited in claim 1, further comprising:
communicating the optimal viewing schedule to the client device for user selection of a recommended video asset; and
receiving the user selection of the recommended video asset from the client device, the user selection initiating a redetermination of the utility of each video asset to update the optimal viewing schedule for the user.

9. A computer-implemented method as recited in claim 1, wherein the one or more recommended video assets include at least one of a television program, a movie, a viral video, or a music video.

10. A system, comprising:
a media content service configured to receive a request for a recommendation of video content from a client device, the recommendation including identifiers of video assets for an optimal viewing schedule for a user;
at least a memory and a processor to implement a video content service configured to:
determine a utility of each video asset that indicates, at least in part, a social value of a video asset to the user;
determine a time relevance of each video asset that is an indication of how soon the user may select to watch the video asset, based at least in part on the social value of the video asset; and
generate the optimal viewing schedule based on the utility of each video asset and the time relevance that is associated with each video asset, the optimal viewing schedule including the identifiers of one or more recommended video assets that, when watched by the user, provide the most social value in the shortest amount of viewing time.

11. A system as recited in claim 10, wherein the video content service is further configured to assess a diversity of each video asset to determine the utility of the video asset, wherein the social value of the video asset to the user also indicates a uniqueness of the video asset.

12. A system as recited in claim 10, wherein the video content service is further configured to apply a discount function to the social value of an additional video asset that includes similar subject matter of the video asset.

13. A system as recited in claim 10, wherein a recommended video asset includes similar subject matter as one or more other video assets, and is recommended as a representative video asset to provide the most social value in the shortest amount of viewing time.

14. A system as recited in claim 10, wherein the utility of the video asset is determined based, at least in part, on a personal value of the video asset to the user, the personal value based on at least one of a video asset selection history, or user preferences.

15. A system as recited in claim 10, wherein the utility of the video asset is determined based, at least in part, on predictions of the video assets that social network contacts of the user will select for viewing, and wherein the social value to the user is the recommendation to watch one or more of the same video assets that the social network contacts select for viewing.

16. A system as recited in claim 10, wherein the utility of the video asset is determined based on the video assets that the user has previously watched, the video assets that social network contacts of the user have previously watched, and predictions of the video assets that the social network contacts of the user will likely select to watch.

17. A system as recited in claim 10, wherein the media content service is further configured to:
communicate the optimal viewing schedule to the client device for user selection of a recommended video asset;
receive the user selection of the recommended video asset from the client device; and wherein
the video content service is further configured to re-determine the utility of each video asset to update the optimal viewing schedule for the user.

18. A system as recited in claim 10, wherein the one or more recommended video assets include at least one of a television program, a movie, a viral video, or a music video.

19. Computer-readable storage media devices comprising instructions that are executable and, responsive to executing the instructions, a computer device:
receives a request for a recommendation of video content from a client device, the recommendation including identifiers of video assets for an optimal viewing schedule for a user;
determines a utility of each video asset that indicates, at least in part, a social value of a video asset to the user, the utility of the video asset being based on the video assets that the user has previously watched, the video assets that social network contacts of the user have previously watched, and predictions of the video assets that the social network contacts of the user will likely select to watch;
determines a time relevance of each video asset that is an indication of how soon the user may select to watch the video asset, based at least in part on the social value of the video asset; and
generates the optimal viewing schedule based on the utility of each video asset and the time relevance that is associated with each video asset, the optimal viewing schedule including the identifiers of one or more recommended video assets that, when watched by the user, provide the most social value in the shortest amount of viewing time.

20. Computer-readable storage media devices as recited in claim 19, further comprising additional instructions that are executable and, responsive to executing the additional instructions, the computer device:
assesses a diversity of each video asset to determine the utility of the video asset, wherein the social value of the video asset to the user also indicates a uniqueness of the video asset; and
applies a discount function to the social value of an additional video asset that includes similar subject matter of the video asset.
